(19) United States
(12) Patent Application Publication
(10) Pub. No.: US 2004/0166197 A1
(43) Pub. Date: Aug. 26, 2004

(54) Environment-friendly chewing gum and method of its manufacture

(76) Inventors: Guillaume Ribadeau-Dumas, Verlinghem (FR); Leon Mentink, Roubaix (FR)

Correspondence Address: STURM & FIX LLP, 206 SIXTH AVENUE, SUITE 1213, DES MOINES, IA, 50309-4076, US

(21) Appl. No.: 10/758,160

(22) Filed: Jan. 15, 2004

(30) Foreign Application Priority Data
Jan. 24, 2003 (FR) 03 00821

(51) Int. Cl. A23G 3/30

(52) U.S. Cl. 426/3

(57) ABSTRACT

The invention relates to a gum base composition for environment-friendly chewing gum, comprising a swelling agent selected from the group comprising the granular starches, in particular hydroxypropylated, ethoxylated and carboxymethylated starches, that can possibly be additionally crosslinked, dried A-granule wheat starch and pregelatinized starches with disintegrating power.

The invention relates to a chewing gum that is more environment-friendly than the chewing gums of the prior art. More precisely, the invention relates to a chewing gum that is less adherent to surfaces than the conventional chewing gums, so that it can easily be detached from the said surfaces.

Chewing gums consist conventionally of a soluble fraction and an insoluble fraction. The soluble fraction generally consists of sweeteners and flavourings. The insoluble fraction consists of a gum base. Natural vegetable derived gums that are insoluble in water, have been used as gum base for many years. However, these vegetable gums were, subject to large fluctuations in price and availability. Chewing gum manufacturers then tried to reproduce the properties of the natural gums by means of synthetic resins, of rubber and other polymers.

This insoluble fraction does not dissolve in the mouth during mastication and cannot be digested by the consumer, who must therefore discard it after consumption. Unfortunately, most often the gums are discarded in places not intended for this purpose, notably outdoor surfaces such as stone and concrete floors, pavements, road surfaces, or indoor surfaces such as carpets, rugs, wooden and plastic flooring, to which they adhere strongly. It is therefore very difficult to clean these surfaces, thus causing a real environmental problem.

Attempts were made to formulate chewing gums having limited properties of adherence, while trying to preserve, as far as possible, the texture of the conventional chewing gums, i.e. elastic and not gritty in the mouth.

Solutions have been proposed, aiming notably to replace completely the usual gum bases with products that are less adhesive.

Document WO 96/20609 describes a non-adhesive gum base notably containing polyvinyl acetates of various molecular weights and a non-fatty and non-waxy plasticizer. In this document, it is stated that nonadhesive gums that are specifically developed for nonadherence to the teeth and to dentures nevertheless still adhere to the surfaces on which they are discarded. Such gums are also described in documents U.S. Pat. No. 3,984,574 and EP 0 134 120.

Document FR 2,263,710 describes the use of a highly and doubly modified starch (hydroxypropylated starch acetate) as gum base. Said starch has very high degrees of substitution and its method of production employs solvents, large quantities of alkaline products and catalysts that are not recommended for use in food. According to this document, the obtained product is in the form of a more or less hard, mucilaginous mass, having elastic properties yet still insoluble in water, like a conventional gum base.

More recently, document WO 01/01788 suggested the use of a maize protein hydrolysate for making a biodegradable chewing gum that can be ingested.

Other solutions consist of replacing only a proportion of the conventional gum base with a compound conferring reduced adherence. Document U.S. Pat. No. 6,017,566 recommends the use of a particular edible polyester with an elastomer for such purpose.

In its turn, document WO 02/17730 relates to the use of lecithin for limiting the adherence of the gum. Lecithin, which is a fatty vegetable derived substance, composes 3 to 15% by weight of the chewing gum formulation.

On the basis that no satisfactory formulation was satisfactory, the applicant endeavoured to improve the state of the art, and thus managed to find a technically and economically viable solution for manufacturing a more environment-friendly gum base. Such gum base is made with vegetable derived excipients that make the gum less adherent to various surfaces.

After much research, the applicant discovered that this aim could be achieved by replacing a proportion of a conventional gum base with a particular selection of starches. Such starches can swell and undergo a volume change in the presence of water in such a way that the points of adherence of the gum base according to the present invention are modified and weakened on its substrate. Consequently, said gum base can be easely detach during cleaning operations, while providing a suitable texture for chewing, and preserving, as far as possible, the usual properties of a conventional gum base.

Therefore, the invention firstly relates to a composition of gum base for a chewing gum that is more environment-friendly, that contains a swelling agent selected from the group comprising the granular starches, in particular starches that have been hydroxypropylated, ethoxylated, carboxymethylated, and can possibly be additionally crosslinked, dried Agranule wheat starch and pregelatinized starches with disintegrating power.

Only the above swelling agents are able to facilitate the removal of the gums, while imparting chewability and texture in the mouth similarly to the conventional chewing gums. In fact, it has been shown in numerous assays that standard native starches other than the A-granule wheat starch give to the chewing gum a gritty texture, with insufficient binding, which is unpleasant in the mouth. This is also the case with pregelatinized starches, having little if any disintegrating power.

Said swelling agents are prepared by conventional techniques familiar to a person skilled in the art.

As for the modified starches, they are hydroxypropylated at a degree of substitution (DS) from 0.05 to 3.

As for the carboxymethylated starch, this can be obtained by alcohol-phase reaction of sodium monochloroacetate in an alkaline medium. This starch is crosslinked beforehand in order to control the swelling of the starch granules.

A-granule wheat starch means the finest granulometric fraction of standard starch.

“Pregelatinized starches with disintegrating power” means, notably, the compositions described in patent EP 964,000 of which the applicant is the holder. These compositions consist of a mixture of standard maize starch and amylose-rich starch, said mixture being pregelatinized in a drying drum. Starches with disintegrating power are known to a person skilled in the art as being totally or partially granular starches that can swell in water. Said starches are used most often in the preparation of pharmaceutical tablets.

Preferably, said swelling agents are added to the gum base composition in the range from 1 to 50% by weight relative to the total weight of the gum base. Preferentially, said gum base contains from 1 to 35% per wieght and preferably from 5 to 25% by weight of said swelling agent.

The composition of gum base according to the invention is suitable for the preparation of all types of chewing gums, which can be formulated with or without sugar, in the form of sticks, dragees, tablets, solid or hollow balls, chewing gums or bubble gums of compressed powder, bubble gums, chewing gum powder for sugar-coating, possibly sugar-coated.

The invention also relates to a chewing gum that contains the said composition of gum base containing a swelling agent selected from the group comprising the granular starches, in particular hydroxypropylated, ethoxylated, and carboxymethylated starches, that can possibly be additionally crosslinked, A-granule wheat starch and pregelatinized starches with disintegrating power.

According to the invention, the gum base composing the insoluble fraction of the chewing gum is preferably ordinary, and similar to those commonly used. Depending on whether we are considering a chewable tablet, a bubble gum, a centre that is to be sugar-coated or a low-calorie chewing gum, said gum base varies between 10% and 95% by weight in the composition according to the invention. Its type will be adapted to the type of chewing gum being manufactured. It can contain, in addition to the said swelling agent, synthetic and/or natural elastomers such as polyisoprene, polyvinyl acetate, polyisobutylene, latices, resins such as terpene resins, polyvinyl esters and alcohols, fats or waxes for example lanolin, vegetable oils partially hydrogenated or not, fatty acids, partial esters of glycerol, paraffin, microcrystalline waxes, fillers such as talc, calcium carbonate, plasticizers of elastomers such as glycerol triacetate, glycerol monostearate, derivatives of rosins, emulsifiers such as lecithin, sorbitol esters, colouring matter or bleaching agents, antioxidants, and antisticking agents such as mannitol.

Preferably, the gum base content into the chewing gum according to the invention varies from 15 to 60% by weight. More particularly, it varies from 20 to 40% by weight.

The gum base can be prepared by conventional techniques, and notably by hot mixing of the ingredients using a mixer. It is also possible to employ methods of chain production, using extruders. The ingredients are mixed homogeneously, the thus obtained mixture is extruded, rolled or cut up, depending on the final form desired. Several ingredients can be added during extrusion, at different feeding points.

The water-soluble fraction of the chewing gum generally contains sweetening agents and a flavouring agent.

The flavouring agent can contain natural and/or synthetic constituents. It can comprise, in particular, flavours of mint, orange, lemon, and other fruits or plants, for example flavours of apple, strawberry, banana, cherry or mixtures of fruits.

The flavouring agent is used in an appropriate amount that can easily be determined by a person skilled in the art, depending on the variety of the gum base, the amount of the gum base, the type of chewing gum and the characteristics of said flavouring agents. Typically, it will be introduced in the range of about 0.2% to about 3% by weight. Preferably, especially for hydrophobic flavouring agents, sufficient quantities will be used to plasticize the gum base without excessive softening of the latter. To achieve this purpose, the flavouring agent content will preferably varies from 0.5% to 1.8% by weight. It is also possible to use a mixture of hydrophobic and hydrophilic flavouring agents at level of about 2% by weight for each flavouring agent. The amount of flavouring agent will also depend on how rich it is in flavour compounds, and on its physical nature. For example, for an encapsulated form, the amount used will usually be smaller.

Sweeteners content is about 5 to about 90% by weight and preferably from 40 to 85% by weight of the chewing gum composition. They are incorporated in a dry or liquid form. Depending on whether a chewing gum is prepared with or without sugar, it is possible to use sugars such as dextrose, sucrose, maltose, fructose, trehalose, lactose or syrups of glucose, fructose, dextrins, individually or mixed together, or polyols such as maltitol, sorbitol, mannitol, xylitol, lactitol, erythritol, isomalt, maltotriitol, iditol, hydrogenated starch hydrolysates, alone or mixed together. It is also possible to use intensive sweeteners, in the free or encapsulated form, such as notably aspartame, acesulfame-K, saccharin and sucralose. The intensive sweeteners composes about 0.02 to about 0.1% by weight of the chewing gum.

It is also possible to intoduce plasticizers in order to optimise the final texture of the gum. Such plasticizers can be selected for example from sorbitol, hydrogenated starch hydrolysates, and glycerol.

Flavouring agents, colouring agents, pharmaceutical active agents, organic acids, vitamins and minerals can also be added.

According to a particular embodiment, the chewing gum according to the invention comprises, by weight relative to its total dry matter:

a) from 15 to 50% of gum base

b) from 1 to 15% of swelling agent

c) from 0.5 to 80% of at least one crystallized polyol

d) from 0 to 10% of a syrup of maltitol

e) from 0 to 10% of a plasticizer

The invention also contemplates a method of making a chewing gum according to the invention, wherein a swelling agent selected from the group comprising the granular starches, in particular starches that have been hydroxypropylated, ethoxylated and that can possibly be additionally crosslinked, carboxymethylated, dried A-granule wheat starch and pregelatinized starches with high disintegrating power, is incorporated in the gum base during or after its manufacture.

The chewing gum according to the invention can be process using any technique known by a person skilled in the art. In practice, the ingredients are mixed sequentially in a kneading machine having a heating system. Typically, the liquid ingredients are first introduced, and then the solid ingredients are incorporated. Once the ingredients are homogenized, the obtained mixture is discharged and shaped by rolling, extrusion, cutting or moulding.

The swelling agent according to the invention is incorporated in the gum base composition preferably before adding the other ingredients.

Said swelling agent represents from 1 to 50% by weight of the total weight of the gum base. Preferentially, the said gum base contains from 1 to 35% by weight and preferably from 5 to 25% by weight of said swelling agent.

By using appropriate ingredients in the gum base, it is also possible to prepare chewing gums according to the invention in the form of powder, tubes and tablets.

The chewing gums according to the invention can be centres that can be sugar-coated. In this case, reference can be made to methods that are known by a person skilled in the art, using sugars or polyols. It is possible, for example, to use the sugar-free coating methods described in patents EP 201,412 B1, EP 625,311 B1, EP 774,201 B1 of which the applicant is the holder.

The invention will be better understood when reading the following specification, which are intended solely for purposes of illustration and are nonlimiting.

### EXAMPLE 1

### Formulation of a Chewing Gum According to the Invention

Two compositions of chewing gum are prepared according to the following formula, the composition according to the invention corresponds to the replacement of 20% by weight of the gum base with a swelling agent.

1.1: Formula

| | | Composition |
|---|---|---|
| | | according to the |
| | CONTROL | invention |
| Gum base | 30.0% | 24.0% |
| (Valencia T - | | |
| CAFOSA) | | |
| Swelling agent | — | 6.0% |
| Sorbitol powder | 45.0% | 45.0% |
| NEOSORB ® P60W | | |
| Xylitol powder | 10.0% | 10.0% |
| XYLISORB ® 90 | | |
| Mannitol 60 | 5.0% | 5.0% |
| Maltitol syrup | 7.8% | 7.8% |
| LYCASIN ® 80/55 HDS | | |
| Mint flavour powder | 0.4% | 0.4% |
| SILESIA | | |
| Mint flavour liquid | 1.8% | 1.8% |
| SILESIA | | |

1.2 Protocol

Load the gum base at 50° C. and the swelling agent in a kneading machine preheated to 50° C. Add half of the sorbitol powder, and the maltitol syrup. Knead for 2 minutes.

Add the mannitol 60, knead for 2 minutes.

Add the xylitol powder, knead for 1 minute.

Add the other half of the sorbitol powder, knead for 2 minutes.

Add the flavouring agents in powder form, knead for 1 minute.

Add the liquid flavouring agents, knead for 1 minute.

Empty the kneading machine, roll into sticks with thickness of 5 mm, and cut up.

1.3 Swelling Agents Tested

Various modified and unmodified starches that replaced 20% by weight of the gum base of the control are tested:

1: hydroxypropylated starch of DS 1.4,

2: hydroxypropylated starch of DS 0.18 crosslinked with 50 ppm of POCl₃ available from the applicant under the name LAB 2552,

3: carboxymethylated starch avalaible from the applicant under the name GLYCOLYS® D,

4: hydroxypropylated wheat starch of DS 0.18 and crosslinked, available from the applicant under the name LAB 2334, pregelatinized by spraying,

5: LAB 2334 pregelatinized in a drum,

6: starch with high disintegrating power available from the applicant under the name LYCATAB® C and prepared according to patent EP 964,000,

7: A-granule wheat starch, dried.

1.4. Measurement of the Hardness of the Sticks

The hardness of the prepared sticks, that is expressed in newtons, is measured on an INSTRON tester.

The results are shown in the following table:

| | | | | D1- | D8- | D15- | D30- |
|---|---|---|---|---|---|---|---|
| | D0- | D0- | D0- | 20° C. | 20° C. | 20° C. | 20° C. |
| | 45° C. | 35° C. | 20° C. | 50% RH | 50% RH | 50% RH | 50% RH |
| CONTROL | 1.2 | 3.2 | 11.8 | 15.7 | 16.1 | 19.9 | 28.4 |
| 1 | 2.1 | 4.7 | 16 | 25.7 | 28.6 | 29.3 | |
| 2 | 1.6 | 3.6 | 13 | 16.5 | 22.9 | 24.8 | |
| 3 | | | | 25.4 | | | 28.3 |
| 4 | 2.1 | 5.7 | 21.9 | 29.4 | 33 | 33.8 | |
| 5 | 1.7 | 4.6 | 17.1 | 22.9 | 27.8 | 27.3 | |
| 6 | 1.6 | 4 | 16.6 | 21.2 | 27.2 | 28 | |
| 7 | | | | 33.9 | | | 48.8 |

Generally speaking, chewing gums in which 20% of the gum base has been replaced with a modified starch are harder than the control. Those whose INSTRON texture is the closest from the control are those prepared with starch LAB 2552.

2. Tasting of the Chewing Gums

The perception in the mouth of the chewing gums in which 20% of the gum base has been replaced is compared with that of the control chewing gums:

The chewing gums (1, 2, 3) containing modified starch or (6) a pregelatinized disintegrating starch have textures in the mouth comparable to those of the control chewing gums, are slightly harder and do not have an aftertaste.

The chewing gum containing A-granule wheat starch has a satisfactory texture and good cohesion, but it has a slight aftertaste.

Chewing gums 4 and 5 containing modified wheat starch have a different “chew” and have poorer binding in the mouth than the control. Chewing gum 4 has a slight aftertaste.

3. Absorption of Water by the Chewing Gums According to the Invention

The chewing gums previously made are immersed in distilled water for evaluating their capacity for absorption of water. The variation in weight of the sticks was measured over time, after drying the surface water with paper.

The results are presented in the following table:

| | Control | 1 | 2 | 4 | 5 | 6 |
|---|---|---|---|---|---|---|
| After | 0 | 0 | 0 | 0 | 0 | 0 |
| 0 days | | | | | | |
| After | 5.3 | 27.1 | 5.6 | 25.4 | 45.7 | 11.5 |
| 1 day | | | | | | |
| After | 8.6 | 30.8 | 7.5 | 46.2 | 61 | 19.5 |
| 2 days | | | | | | |
| After | 12.1 | 36.7 | 17.2 | 52.5 | 66.8 | 26.1 |
| 4 days | | | | | | |
| After | 15.3 | 39.4 | 23.6 | 53.4 | 69.3 | 30 |
| 7 days | | | | | | |
| After | 24 | 41.5 | 27.2 | 54.6 | 71 | 30.8 |
| 10 | | | | | | |
| days | | | | | | |

(% of water absorbed by the immersed chewing gums)

Chewing gums 4 and 5 absorb water more quickly and absorb more water than the control.

Chewing gum 1 absorbs a little more water than the control.

Chewing gum 2 is comparable to the control.

4. Evaluation of the Adhesiveness of the Chewing Gums

The adhesiveness of the gums according to the invention is evaluated using the following test:

5 grams of chewing gum are chewed for 5 minutes,

the gum is then stuck on a concrete substrate, and then detached manually from the substrate,

detachment of the gums is evaluated visually: from easy (+++++) to very difficult (+).

The results are shown in the following table:

| Control (Valencia T) | + |
|---|---|
| 5 | ++ |
| 4 | ++ |
| 7 | ++ |
| 6 | +++ |
| 3 | +++ |
| 2 | +++ |
| 1 | ++++ |

These results show that the chewing gums (1, 2, 3, 6) containing hydroxypropylated starch, crosslinked hydroxypropylated starch, carboxymethylated starch and disintegrating pregelatinized starch can be detached easily from their substrate. Chewing gums 4 and 5 are less easily detachable, but are still superior to the control.

The best results are obtained with ethanol-phase hydroxypropylated starch.

Conclusion: replacement of 20% of gum base with an ethanol-phase hydroxypropylated starch, with a disintegrating pregelatinized starch or with a crosslinked hydroxypropylated starch makes it possible to achieve the objectives of the present invention: no major change in texture or taste of the chewing gums and reduction in adhesiveness. In contact with water, the chewing gums according to the invention absorb more water than the control, which reflects their ease of detachment.

1. Composition of gum base for environment-friendly chewing gum, comprising a swelling agent selected from the group comprising granular starches, in particular hydroxypropylated, ethoxylated and carboxymethylated starches, that can possibly be additionally crosslinked, dried A-granule wheat starch and pregelatinized starches with disintegrating power.

2. Composition of gum base according to claim 1, wherein the swelling agent represents from 1 to 50% by weight of the total weight of the gum base.

3. Composition of gum base according to claim 2, wherein the gum base contains from 1 to 35% by weight, preferably from 5 to 25% by weight of said swelling agent.

4. Chewing gum comprising a gum base composition according to claim 1.

5. Chewing gum according to claim 4, comprising from 15 to 60% by weight of the said gum base.

6. Chewing gum according to claims 5, comprising from 20 to 40% by weight of said gum base.

7. Environment-friendly chewing gum, comprising by weight relative to its total dry matter:
from 15 to 50% of gum base
from 1 to 15% of swelling agent
from 0.5 to 80% of at least one crystallized polyol
from 0 to 10% of a syrup of maltitol
from 0 to 10% of a plasticizer,
said swelling agent being selected from the group comprising the granular starches, in particular hydroxypropylated, ethoxylated and carboxymethylated starches, that can possibly be additionally crosslinked, dried A-granule wheat starch and pregelatinized starches with disintegrating power.

8. Method of preparation of an environment-friendly chewing gum, wherein a swelling agent is selected from the group comprising granular starches, in particular hydroxypropylated, ethoxylated and carboxymethylated starches, dried A-granule wheat starch and pregelatinized starches with disintegrating power, is incorporated in the gum base.

9. Method according to claim 8, wherein the amount of said swelling agent that is incorporated in the gum base varies from 1 to 50% by weight relative to the total weight of the gum base.
